(19) United States
(12) Patent Application Publication
(10) Pub. No.: US 2010/0077890 A1
(43) Pub. Date: Apr. 1, 2010

(54) MULTIPURPOSE OPENER

(76) Inventors: Gabe Neiser, Port Jeferson Station, NY (US); Alan Randmae, Centerport, NY (US)

Correspondence Address: TUTUNJIAN + BITETTO, P.C., 20 CROSSWAYS PARK NORTH, SUITE 210, WOODBURY, NY, 11797, US

(21) Appl. No.: 12/240,083

(22) Filed: Sep. 29, 2008

(51) Int. Cl. B25F 1/00; B26B 11/00; B25C 11/00

(52) U.S. Cl. 81/3.09; 81/3.55; 254/28; 7/160

(57) ABSTRACT

A multi-purpose opener including a head portion having a top side, a bottom side and a tip, the head portion being connected to a handle at a first angle. The head portion includes a curved member protruding from the top side of the head portion and an elongate hook-like member protruding from the bottom side. A pronged element is provided protruding from the tip of the head portion.

### BACKGROUND

1. Field of Technology

The present principles relate to packaging openers, and more particularly, they relate to a multi-purpose device for use with opening a variety of packages and packaging materials.

2. Description of Related Art

Goods may be packaged in a variety of ways to ensure their safe and secure containment and transport. In particular, containers for goods must be sealed securely to prevent the contents from being unintentionally released and damaged. For example, packaging such as cartons or boxes may include layers of tear-resistant tape (e.g., vinyl or plastic tape) or multiple staples to seal their contents securely within. Other types of packaging may include shrink-wrap type materials comprised of polyurethane or plastic which are designed to be tear and/or puncture-resistant. Such materials may further be heat-sealed closed during the manufacturing process.

While secure packaging and containment of goods is desirable for many reasons, it can be challenging to open such packaging safely and efficiently. For example, the plastic used in certain packaging is typically difficult, if not impossible, to rip open manually. As such, instruments such as scissors, razor blades and knives may be used to open packaging, which may pose a potentially dangerous situation since such objects are often unsuited to or lack special adaptation to open certain types of packaging and thus may be awkward to handle, increasing the likelihood of accidental injury to the user or damage to the contents of the package as a result.

Although there have been a number of devices developed for facilitating opening of specific types of packaging, the diverse and almost infinite variety of packaging and container configurations, types, shapes and sizes can male it difficult to open many different packages and packaging configurations with just a single tool. Keeping multiple opening tools on hand, however, is inconvenient and contributes to undesired clutter and unnecessary expense.

Thus, it would be desirable to provide a tool or device for opening a variety of packages and packaging materials efficiently and safely that eliminates the need for the purchaser to use multiple tools or potentially dangerous instruments to open the package, and which further enables the purchaser to easily open the package without damaging the contents thereof.

### SUMMARY

It is therefore an aspect of the present principles to provide a multi-purpose packaging opener that provides a safe, efficient and ergonomic way for opening, cutting and/or removing a variety of packages and packaging materials.

It is yet another aspect of the present principles to provide a packaging opener that minimizes exposure of sharp edges to the user and maximizes ease of handling.

A further aspect of the present principles is to provide a packaging opener that does not damage the contents of a package.

These and other aspects are achieved in accordance with an implementation of the present principles wherein a multi-purpose opener is provided comprising a head portion having a top side, a bottom side and a tip, the head portion being connected to a handle at a first angle. The head portion includes a curved member protruding from the top side of the head portion, an elongate hook-like member protruding from the bottom side, and a pronged element protruding from the tip.

According to another aspect of the present principles, a multi-purpose packaging opener is provided including a head portion having a top side, a bottom side and a tip, the head portion being connected to a handle at a first angle. The head portion includes a curved member protruding from the top side of the head portion, an elongate hook-like member protruding from the bottom side and defining an elongate passage together with a contoured portion jutting from the bottom side, and a pronged element protruding from the tip, wherein a cutting edge is provided affixed to the head portion and disposed within said elongate passage.

According to yet another aspect of the present principles, a multi-purpose opener is provided comprising a plate member having left and right lateral sides, a top edge, a bottom edge and a tip portion. The plate member includes a curved member protruding from the top edge, a pronged element protruding from the tip portion, and a blade integrally formed at the bottom edge. A head portion is provided comprising a left side portion and a right side portion, each of said left and right side portions configured for fitting over respective left and right lateral sides of the plate member and allowing said curved member, pronged element and cutting edge to protrude from the head portion.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a side perspective view of an exemplary multi-purpose opener according to an aspect of the present principles;

FIG. 2 is a side view of an exemplary package opener according to an aspect of the present principles;

FIG. 3 is a top view of an exemplary package opener according to an aspect of the present principles;

FIG. 4 is an exploded view of an exemplary packaging opener according to an aspect of the present principles;

FIG. 5 is a front perspective view of an exemplary packaging opener positioned to cut packing tape on a box using a curved cutting member according to an aspect of the present principles;

FIG. 6 is a perspective view of an exemplary packaging opener positioned to remove staples from a container according to an aspect of the present principles; and

FIG. 7 is a front perspective view of an exemplary packaging opener positioned to pierce packaging using a hook-shaped protruding member according to an aspect of the present principles.

### DETAILED DESCRIPTION

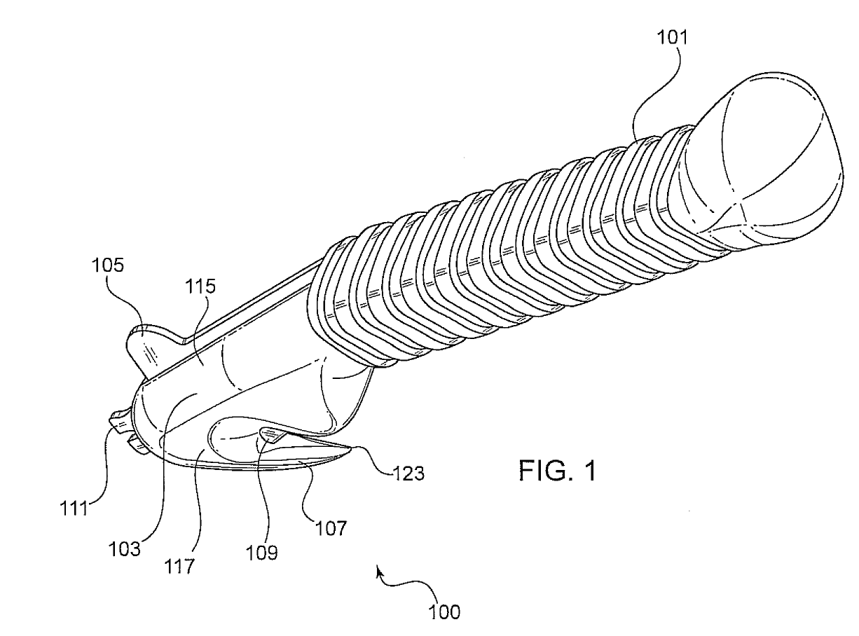

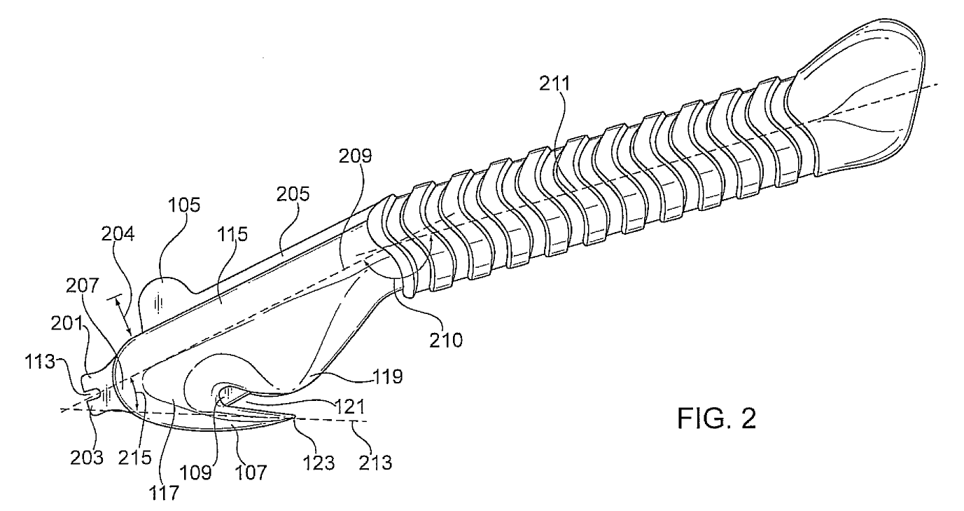

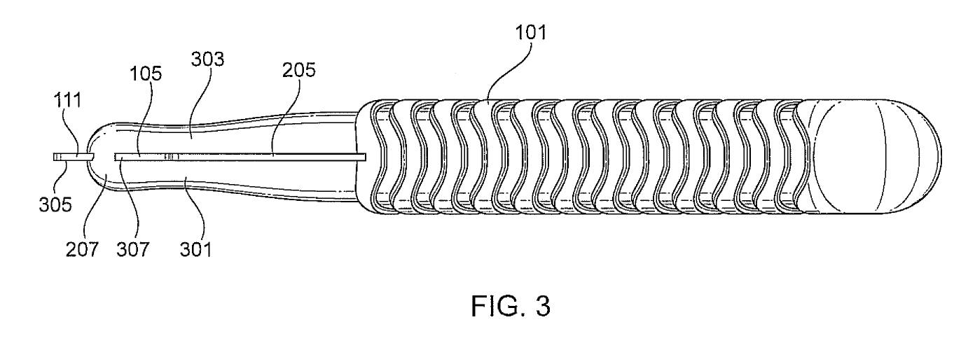

FIGS. 1-4 show various views of an exemplary multi-purpose packaging opener according to an aspect of the present principles. The packaging opener 100 comprises a handle 101 having a longitudinal axis 211. One end of the handle 101 includes a head portion 103 attached thereon, preferably at an angle 210. The angle 210 may comprise, e.g., approximately 165 to 175 degrees. Advantageously, the angular attachment of the head portion 103 to the handle 101 facilitates manipulation and handling of the opener 100 during use, optimizes ergonomics, and enables a user to cut and open packaging comfortably and with minimal effort. The handle 101 may comprise, e.g., rubber or plastic materials preferably formed and contoured to maximize ergonomic fit and comfort, and may further include a plurality of ridges for improved traction and grip.

In one exemplary implementation, the head portion 103 comprises an elongate structure having a longitudinal axis 209, two opposing sides 301 and 303, a tip 207 distal from the head portion's 103 point of attachment to the handle 101, a top surface 115, and a bottom surface 117. As discussed above, the head portion 103 and the handle 101 are preferably attached such that their respective longitudinal axes, 209, 211 intersect at an angle that facilitates the most ergonomic design. The head portion 103 may be comprised of any rigid materials which may, for example, be moldable/deformable during processing of the head 103 to achieve a desired shape, e.g., plastic, polycarbonate, metal, composites using a polymer matrix material (e.g., a resin solution), fiber-reinforced polymers, etc.

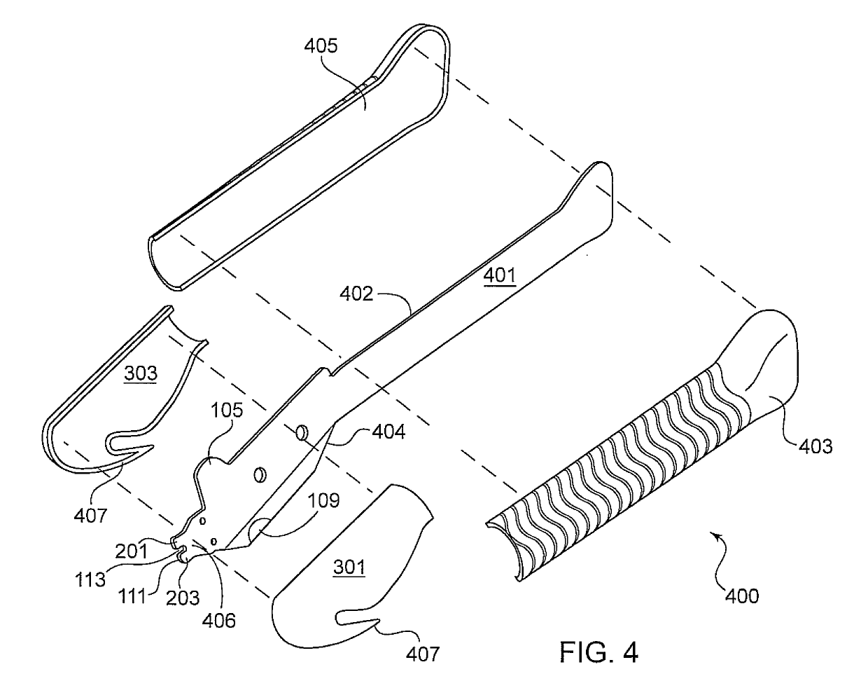

The head portion 103 preferably includes multiple structures formed thereat and/or protruding there from for performing a plurality of different functions. Such structures may be integrally formed with the head portion 103 and/or comprise entirely separate materials from the head portion 103, for example, being configured to protrude from a common plate member (described further with reference to FIG. 4) which is secured within the two opposing sides 310, 303.

With regards to the multiple structures, for example, the head 103 may include a curved member 105 protruding from the top surface 115. The curved member 105 is preferably comprised of a rigid, durable and shatter-resistant material (e.g., metal, carbon or nylon composites, etc.) and may, e.g., in side profile be in the form of a semi-circular or “C” shape and includes a square edge 307. A distance 204 from which the curved member 105 protrudes from the head portion 103 at least about 0.35 inches, and can be in a range of ⅛ to ⅞ of an inch.

Advantageously, the curved member 105 is configured for effective piercing and penetration of packaging materials, such as tape or plastic wrap, yet by way of its curved side profile and square edge, minimizes the risk of serious injury due to accidental contact with same. An elongate member 205 may also be provided protruding from the head portion 103 and extending longitudinally along the length of the top 115. In one exemplary implementation, the elongate member 205 may also have a square edge and be contiguous with the curved member 105.

The head portion 103 may further include a hook-shaped member 107 formed at and protruding from the bottom surface 117. For example, the hook member 107 may comprise an elongate conical protrusion having a sharp tip 123, which, together with the bottom surface 117 of the head portion 103 (e.g., a contoured portion 119 jutting from the bottom surface 117), defines an elongate passage 121 which houses a blade 109. The blade 109 may be comprised of any hard, durable material, preferably metal or metal composites, and includes a sharpened cutting edge. The hook member 107 may be comprised of any rigid, durable material and in one implementation, may be integrally formed with the head portion 103 and molded into the desired hook-like shape.

According to one exemplary aspect of the present principles, the hook member 107 is configured to protrude at an angle relative to the head portion 103, e.g., such that a longitudinal axis 213 of the hook member 107 intersects the longitudinal axis 209 of the head portion 103 at an angle 215. The angle 215 preferably is in the range of about 10 to about 60 degrees, and in shown at around 30 degrees.

Any materials desired to be contacted with the blade 109 are preferably passed and fitted through the passage 121 before they can be cut. Advantageously, the hook member 107 configuration and shape thus not only provides the ability to perform puncturing actions for cutting packaging materials but further restricts access and unintentional exposure to the sharp cutting edge of the blade 109, thus also functioning as a permanent, rigid guard for the blade 109 to prevent accidental injury or damage due to unintentional contact with the blade by fingers, hands, objects not desired to be cut, etc.

A multi-pronged member 111 affixed to and protruding from the tip 207 of the head portion 103 may further be provided. The pronged member 111 is preferably made of, e.g., a rigid, durable and shatter-resistant material (e.g., metal, carbon or nylon composites, etc.) and in one exemplary implementation comprises, e.g., a pair of prong-shaped elements 201, 203 which define a U-shaped notch 113. The pronged member 111 preferably includes square edges 305. The prongs 201, 203 are configured to be insertable under e.g., clips, staples and/or other fasteners for prying them loose and removing them. The shape and orientation of the notch 113 advantageously assists in seizing and gripping a staple or fastener, thus facilitating grasping, lifting and removal of same.

FIG. 4 depicts an exploded view of an exemplary opening device 400 according to an aspect of the present principles. According to one exemplary implementation, the device 400 may comprise a substantially flattened plate member 401 formed preferably of a rigid, moldable and/or formable material which may further be sharpened to form at least one cutting edge thereon. For example, die plate 401 may be comprised of metal, metal alloys or composites, etc. The plate 401 preferably includes a plurality of structures formed integrally thereon, e.g., a curved member 105 may be formed at a top edge 402 of the plate 401, a cutting edge 109 may be formed at a bottom edge 404 of the plate, and a pronged element 111 may be formed at a tip portion 406 of the plate 401.

The plate 401 is configured for placement and securing between left and right sides 301, 303 of the head portion, with a portion of the plate 401 being further securable within a handle, e.g., between left and right portions 403, 405, of a handle which may be snap-fit together. The plate 401 is secured such that its plurality of structures (e.g., curved member 105, cutting edge 109 and pronged element 111) are caused to fixedly protrude from the head portion 301, 303, for example, as shown in FIG. 1. The elongate hook-shaped element 107 may be formed integrally with the head portion 103, with each lateral half of the hook-shaped element 407 being formed at each of sides 301, 303. When each of sides 301, 303 are assembled and joined together, holding the plate 401 there between, the hook-shaped member 107 is thus formed.

Advantageously, the solid one-piece construction and securing of the plate 401 within the head portion and handle impart improved stability and strength to the device 400, especially during twisting, pulling and pushing motions during use.

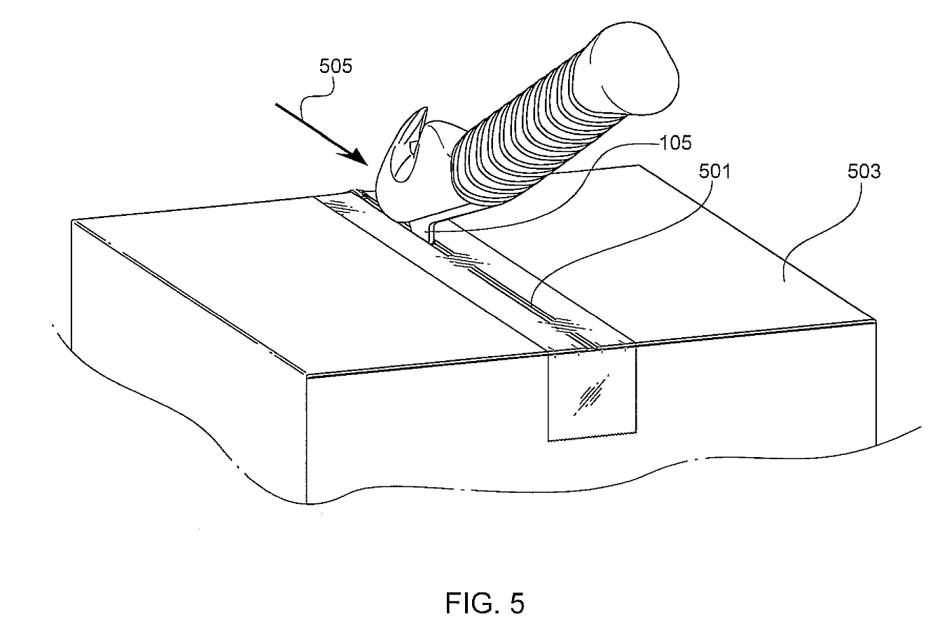

FIGS. 5-7 depict various exemplary illustrations of the opener 100 during use. For example, as shown in FIG. 5, the curved member 105 of the opener 100 may be positioned to be inserted into a taped seam 501 of a box 503, and pulled in direction 505 to cut the tape. The square edge 307 of the curved member 105 advantageously enables effective and prompt severing and puncturing of the taped seam, yet is not so sharp as to pose a risk of serious injury when used properly.

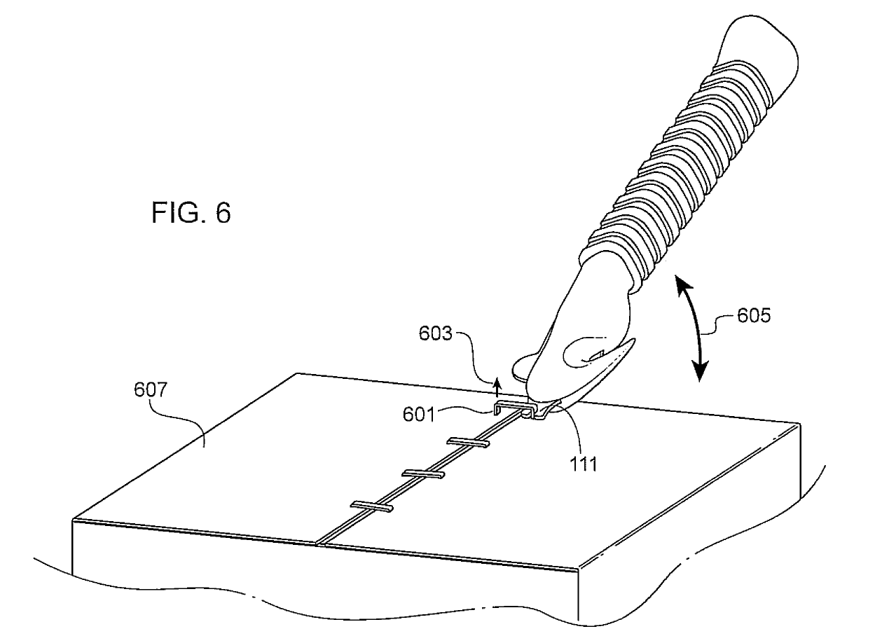

FIG. 6 depicts the opener 100 positioned to remove staples according to another exemplary use of the opener 100 according to an aspect of the present principles. For example, the pronged member 111 may be inserted beneath a staple 601, the notch 113 preferably being fitted around a ‘leg’ of the staple as shown. Once secured under a staple, the opener 100 is pivoted in direction 605, thus pulling the staple 601 upwards in direction 603 to remove the staple 601 from the box 607.

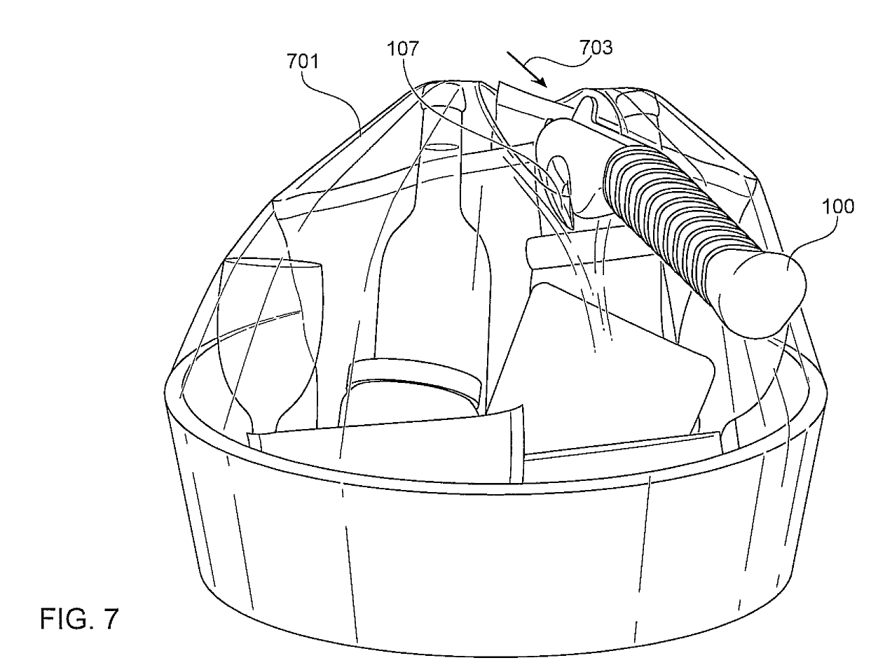

FIG. 7 depicts the opener 100 positioned to pierce and cut open plastic wrapping according to another exemplary use of the opener 100 according to an aspect of the present principles. For example, the tip 123 of the hook element 107 may be inserted into the wrapping 701 and pulled in a direction 703 which causes the wrapping material 701 to come into contact with and be sliced by the blade 109, thus efficiently and easily removing the wrapping 701 with minimal risk of damage to the contents under the wrapping.

Other uses and/or positioning orientations of the multi-purpose opener device 100 (not shown) for, e.g., opening a variety of packaging materials may be contemplated.

While there have been shown, described and pointed out fundamental novel features of the present principles as applied to implementations thereof, it will be understood that various omissions, substitutions and changes in the form and details of the methods described and devices illustrated, and in their operation, may be made by those skilled in the art without departing from the spirit of the present principles. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A multi-purpose opener comprising:
a head portion having a top side, a bottom side and a tip, the head portion being connected to a handle at a first angle, the head portion including:
a curved member protruding from the top side of the head portion; and
an elongate hook-like member protruding from the bottom side.

2. The multi-purpose opener of claim 1, wherein the hook-like member defines an elongate passage together with the bottom side of the head portion.

3. The multi-purpose opener of claim 2, further comprising a blade disposed within the passage and affixed to the head portion.

4. The multi-purpose opener of claim 1, wherein the elongate hook-like member is connected to the head portion at a second angle.

5. The multi-purpose opener of claim 1, wherein the curved member and the pronged element have square edges.

6. The multi-purpose opener of claim 1, wherein the pronged element comprises two prongs defining a notch.

7. The multi-purpose opener of claim 1, further comprising a pronged element protruding from the tip.

8. A multi-purpose packaging opener comprising:
a head portion having a top side, a bottom side and a tip, the head portion being connected to a handle at a first angle, the head portion including:
a curved member protruding from the top side of the head portion; and
an elongate hook-like member protruding from the bottom side and defining an elongate passage together with a contoured portion jutting from the bottom side.

9. The multi-purpose opener of claim 8, wherein the elongate hook-like member is connected to the head portion at a second angle.

10. The multi-purpose opener of claim 8, wherein the curved member and the pronged element have square edges.

11. The multi-purpose opener of claim 8, wherein the pronged element comprises two prongs defining a U-shaped notch.

12. The multi-purpose opener of claim 8, further comprising a pronged element protruding from the tip, wherein a cutting edge is provided affixed to the head portion and disposed within said elongate passage

13. A multi-purpose opener comprising:
a plate member having left and right lateral sides, a top edge, a bottom edge and a tip portion, the plate member including:
a curved member protruding from the top edge;
a pronged element protruding from the tip portion; and
a blade integrally formed at the bottom edge; and
a head portion comprising a left side portion and a right side portion, each of said left and right side portions configured for fitting over respective left and right lateral sides of the plate member and allowing said curved member, pronged element and cutting edge to protrude from the head portion.

14. The opener of claim 13, wherein the curved member and the pronged element have square edges.

15. The opener of claim 13, wherein the pronged element comprises two prongs defining a U-shaped notch.

16. The opener of claim 13, wherein each of the left and right side portions of the head portion includes a lateral half of an elongate hook-like member protruding from a bottom side of each of the left and right side portions and defining an elongate passage together with a contoured portion jutting from said bottom side.

17. The opener of claim 13, wherein each of the left and right side portions of the head portion are configured to be affixed to each other with the plate member disposed in between.

18. The opener of claim 13, wherein the curved member comprises a semi-circular shaped member.
